(19) United States
(12) Patent Application Publication
(10) Pub. No.: US 2003/0208609 A1
(43) Pub. Date: Nov. 6, 2003

(54) Automatic configuration of advanced services over DSL

(75) Inventor: Michael Stuart Brusca, Hicksville, NY (US)

Correspondence Address: LEONARD C. SUCHYTA, c/o CHRISTIAN R. ANDERSEN, VERIZON SERVICES GROUP (mailcode HQE03H01), 600 HIDDEN RIDGE DRIVE, IRVING, TX, 75038, US

(73) Assignee: Verizon Services, Corp.

(21) Appl. No.: 10/136,961

(22) Filed: May 1, 2002

(51) Int. Cl. G06F 15/16

(52) U.S. Cl. 709/230; 709/223

(57) ABSTRACT

A method for facilitating a configuration of a device to access a network service includes (a) receiving, in a first protocol format, a request for information for configuring the device, (b) retrieving the information, in a second protocol format, from a directory system, (c) converting the information from the second protocol format to the first protocol format, and (d) transmitting the information, in the first protocol format, in response to the request. The method may also include converting the request from the first protocol format to the second protocol format.

### BACKGROUND OF THE INVENTION

1. Field of the Invention

The present invention relates to a process for providing services to Digital Subscriber Line (DSL) subscribers. More particularly, the present invention relates to automatically configuring a wide range of advanced DSL services.

2. Description of the Prior Art

A Digital Subscriber Line (DSL) is a telecommunications connection to a subscriber's premises that enables a delivery of broadband services. The subscriber may be an individual or a business. A typical DSL architecture usually includes a Network Access Provider (NAP) and one or more Network Service Providers (NSP). The NAP provides connectivity between the subscriber and the NSP, and the NSP provides broadband services, such as high speed Internet access, email hosting, and virtual private networks (VPNs).

A subscriber's network equipment at the subscriber's location is generally referred to as Customer Premises Equipment (CPE). The CPE includes one or more devices that provide a connection to a DSL telephone line. Such a device is known as a Broadband Network Termination (B-NT) by the International Telecommunications Union (ITU), and is also referred to as an Asymmetrical Digital Subscriber Line Termination Unit-Remote (ATU-R) by the American National Standards Institute (ANSI). One example of a B-NT or ATU-R is a DSL modem.

A physical installation of DSL services at a subscriber's location typically includes connecting a B-NT to an incoming DSL telephone line. The B-NT is then connected to other CPE. The other CPE may include telecommunications equipment such as one or more routers, hubs, personal computers, or workstations. Additional components such as network interface cards may also be installed in the individual components of the CPE.

The B-NT is then configured, that is, software is loaded to support the particular services that the subscriber desires. A portion of the software may be down loaded from a computer or loaded from a disk. The software typically includes one or more communication protocols that allow the B-NT to exchange information with other devices on the Internet.

Once basic communications protocols are loaded, the B-NT may be further configured by automatically loading additional software from other devices. As an example, Asynchronous Transport Mode (ATM) is a communications protocol that may be automatically configured by an automatic set up process. With ATM configuration, one or more Permanent Virtual Circuits (PVCs) are allocated connections between devices that are always available. A PVC is usually set up with traffic parameters and other attributes that are specific to the subscriber's service. A physical connection from a subscriber's CPE to an NAP is established along with another connection from an NAP to an NSP. One or more NSPs may then create and set up additional connections, such as PVCs, that automatically connect to the PVC between the NAP and the subscriber's B-NT, for example, to provide the subscriber with a network service, such as Internet access or a more secure network service such as Virtual Private Network (VPN).

The automatic creation and set up of network services is referred to as auto-configuration. A mechanism for auto-configuration of PVCs may use Integrated Local Management Interface (ILMI). ILMI is an ATM communications protocol that may be used for sending configuration and other management information between network devices. Automatic configuration of a PVC using ILMI includes establishing a set of parameters in the form of a Management Information Base (MIB), and using those parameters to configure a PVC's Virtual Path Identifier (VPI) and Virtual Circuit Identifier (VCI). These identifiers allow a B-NT to establish a connection to a particular NSP, through an NAP's network.

Point to Point Protocol (PPP) and Dynamic Host Configuration Protocol (DHCP) are examples of other protocols presently used for auto-configuration. PPP is a simple communication protocol for exchanging various types of information, including configuration information, between networked devices. PPP provides for message exchange and subscriber identification, or authentication, between the B-NT and only a single NSP. DHCP is designed specifically to provide configuration parameters to networked devices. As such, DHCP includes two components, a communication protocol for delivering configuration parameters from a DHCP server, and a mechanism for allocation of network addresses.

The auto-configuration mechanisms described above are sufficient for automatic configuration of routine services, such as Internet access, where a single NSP provides a single service. That is, a device needing to obtain configuration information for a routine service may obtain the information by employing a the aforementioned ATM, PPP or DHCP processes, and such information must be obtained from a specific server that represents only a single service provider. For more advanced services involving an NAP and one or more NSPs, a subscriber is limited to obtaining advanced service from those NSPs that have pre-established agreements with the NAP. Examples of such advanced services include video on demand, video conferencing, video gaming, broadcast and unicast video, as well as audio, such as web radio and CD quality audio. At the present time, a subscriber that desires video on demand, for example, is limited to those video providers that, under an agreement with the subscriber's NAP, have provided configuration information specific to their particular service. The protocols presently utilized by NAP's are capable of supporting only a limited number of different network services, and a limited number of downloadable configuration parameters.

There are no known automatic configuration solutions for advanced Internet Protocol (IP) based services or complex ATM services over DSL. Advanced services are typically provided by different NSPs, and each NSP may require different PVCs with different attributes that vary according to the service being provided. In addition to Internet access, some advanced services may require a second or more PVCs with various traffic parameters that may vary depending on a subscriber's CPE and the service requested by the subscriber. Furthermore, the protocols presently used for auto-configuration are not capable of storing complex configuration information for a large number of NSPs providing a large variety of services.

Simple Network Management Protocol (SNMP) and Lightweight Directory Access Protocol (LDAP) are two other protocols presently used in networking applications. However, they are not presently used together for automatic configuration of DSL systems.

SNMP uses a manager/agent paradigm where the manager issues messages to retrieve information, and the agent sends messages containing information in response. The information sent by the agent is usually retrieved from an MIB. ILMI, described above, is a derivation of SNMP.

LDAP runs on a system that includes a directory and a directory information tree. LDAP itself is a network protocol for accessing information in the directory, and an information model defining how the information is stored. An LDAP directory supports any type of information, and each entry in the directory has a unique name called a Distinguished Name (DN). The LDAP protocol supports various forms of security including authentication, privacy, and data integrity.

There are millions of conventional B-NTs and ATU-Rs installed at locations throughout the world. Conventional B-NTs and ATU-Rs are capable of communicating using the SNMP protocol, but they do not ordinarily communicate using the LDAP protocol, and consequently, they are not capable of directly interfacing with an LDAP directory. This is due, in part, to the conventional BNT and ATU-R having an SNMP client, but not an LDAP client. Even if it is technically feasible to modify a B-NT or ATU-R to communicate using the LDAP protocol, the cost and logistics of doing so, particularly for a large number of such devices, may be prohibitive.

### SUMMARY OF THE INVENTION

It is an object of the present invention to expand the present automated configuration process for DSL subscribers and service providers.

It is another object of the present invention to automatically provide additional or enhanced services as part of the expanded auto-configuration process.

It is yet another object of the present invention to automatically reconfigure existing subscribers to provide additional or enhanced services.

It is an additional object of the present invention to automatically reconfigure existing subscribers from any of a plurality of network service providers.

It is a further object of the present invention to expand the present automated configuration process and to provide reconfiguration processes by enabling a B-NT to use a succession of protocols to gather configuration information.

It is a further object of the present invention that, as the capabilities of each protocol are reached, additional protocols are utilized until all available configuration information has been acquired for the services a subscriber desires.

It is a further object of the present invention to expand the present automated configuration process and to provide reconfiguration processes by using LDAP to operate a central directory in combination with SNMP.

These and other objects and advantages of the present invention are achieved by a method for facilitating a configuration of a device to access a network service. The method includes (a) receiving, in a first protocol format, a request for information for configuring the device, (b) retrieving the information, in a second protocol format, from a directory system, (c) converting the information from the second protocol format to the first protocol format, and (d) transmitting the information, in the first protocol format, in response to the request. The method may also include converting the request from the first protocol format to the second protocol format. There is also provided an apparatus for performing such a method.

Another embodiment of the present invention is a method for facilitating a configuration of a device to access a network service. The method includes (a) receiving, in a simple network management protocol (SNMP) format, a request for information for configuring the device to access a digital subscriber line (DSL) service, (b) sending a request for the information, in a lightweight directory access protocol (LDAP) format, to an LDAP directory system, (c) receiving the information, in the LDAP format, from the LDAP directory system, (d) converting the information from the LDAP format into the SNMP format, and (e) transmitting the information from the SNMP protocol server, for configuring the device. The method may also include converting the request from the SNMP format into LDAP format. There is also provided an apparatus for performing such a method.

### BRIEF DESCRIPTION OF THE DRAWINGS

FIG. 1 shows a diagram of an example DSL system for automatic configuration of a B-NT in accordance with the present invention;

FIG. 2 shows a diagram of an LDAP directory information tree in accordance with the present invention;

FIG. 3 shows an automatic configuration procedure utilizing a succession of protocols;

FIG. 4 shows a diagram of the commands used by a SNMP manager to configure the settings of an SNMP agent; and

FIG. 5 shows a “reverse SNMP procedure” where the SNMP manager is a client and the SNMP agent is a server.

### DETAILED DESCRIPTION OF THE INVENTION

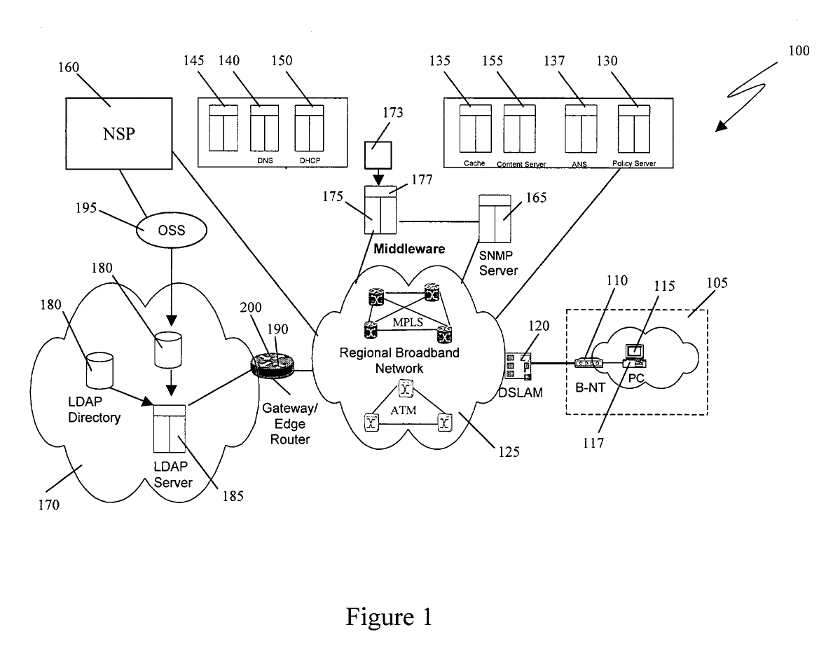

Referring to the figures and, in particular, FIG. 1, there is shown a diagram of an exemplary DSL system, generally represented by reference numeral 100, that provides automatic configuration of advanced services in accordance with the present invention.

CPE 105 includes a personal computer (PC) 115 and a B-NT 110. B-NT 110 preferably connects PC 115 to a digital subscriber line access multiplexer (DSLAM) 120, which is located at a telephone service provider's central office and provides connections between one or more subscribers and a regional broadband network 125. Regional broadband network 125 preferably supports various communication protocols, for example ATM. In addition, regional broadband network 125 preferably provides for routing packets by using labels with a technique such as multi-protocol label switching (MPLS).

DSL system 100 preferably has a policy server 130 that holds the policies of the network, for example, how priorities and bandwidth are assigned. DSL system 100 includes an authentication server 145, a Domain Name Service (DNS) 140, a cache 135 for temporary storage, and possibly an ATM Name Server (ANS) 137. DSL system 100 may also include a DHCP system 150 and one or more content servers 155 for delivering routine or complex services to subscribers. A connection to one or more NSPs 160 is also provided through regional broadband network 125. In addition, DSL system 100 has a gateway/edge router 200, which may be one of a plurality of such gateway/edge routers, that operates as an interface to other systems. Gateway/edge router 200 may also provide a platform on which a PPP server 190 may reside.

A “converter”, in the context of the present invention, converts data from a first protocol to a second protocol, for example, from SNMP into LDAP, and vice versa. This is done through mapping or translating one type of information to another, whereby both forms of the information would have the same meaning. As a further example, such converted information could include all of, or part of, an MIB or schema or other representation of data. The converter preferably resides in a server within a network.

A “directory system” in the context of the present invention, includes a structure of information that is represented and stored in a database. LDAP is a preferred implementation of such a directory system because it uses a directory information structure, such as a directory information tree (DIT), that is extensible, i.e., the database structure can be extended to include additional fields or branches so that it is not constrained by its initial design, and it also includes a protocol, i.e., LDAP protocol, to communicate with the database. LDAP also supports authentication. However, the present invention is not limited to use of an LDAP directory system, but can use any directory system that can be accessed, modified and extended, such as X.500, extensible markup language (XML), and Common Open Policy Service Protocol (COPS).

SNMP is a network management protocol that is used to monitor and configure network equipment. It is particularly well suited for use in the present invention because it is widely utilized in the field of computer networking, and there exists a set of well-defined MIBs associated with SNMP. Furthermore, SNMP employs a server/agent relationship within a network or between networks.

In accordance with the present invention, DSL system 100 has a protocol server, shown as an SNMP server 165, a directory system, shown as an LDAP system 170, and a converter, shown as middleware 175. LDAP system 170 is connected to regional broadband network 125 through gateway/edge router 200.

LDAP directory system 170 is a repository of auto-configuration information. DSL system 100 may include any number of LDAP directory system 170s, but a preferred arrangement is to have one such LDAP system 170 per DSL service provider. LDAP directory system 170 has one or more LDAP directories 180 and an LDAP server 185.

LDAP directories 180 of the present invention include an identification of NSPs 160 that are accessible by a subscriber, the services that each NSP 160 provides, and configuration information for accessing the services. LDAP directories 180 may also include configuration information for each service based on various types and combinations of CPE. LDAP directories 180 may be populated through a network management system called an Operations Support System (OSS) 195. NSPs 160 may supply OSS 195 with configuration information for the services they provide and may also update the configuration information periodically.

The information in a directory system, such as LDAP system 170, is accessed using directory system messages. For purposes of this invention, directory system messages are messages for identifying entries in a directory structure, such as LDAP directories 180. Directory system messages may include search parameters or other attributes for identifying directory entries.

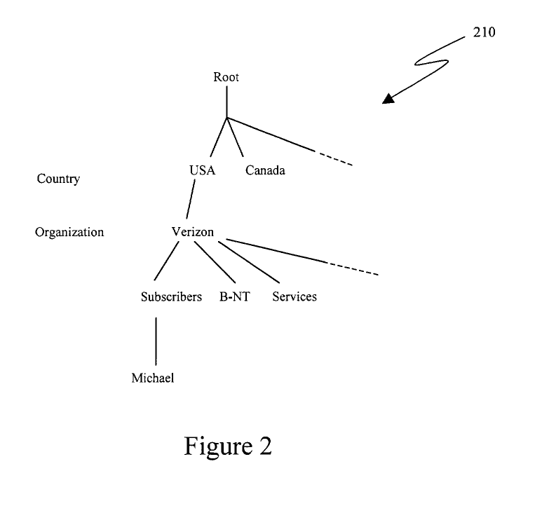

FIG. 2 shows an exemplary directory information tree that may be used for organizing the information in LDAP directories 180. The information may be organized first by country, then by business organization, and then by various aspects of that organization, for example, by subscriber, CPE, and available services.

Middleware 175 is an apparatus having software that converts SNMP information to LDAP information and vice versa. It serves as an interface between SNMP server 165 and LDAP system 170.

The auto-configuration operation in accordance with the present invention will now be described with reference to FIGS. 2 through 5. During installation, B-NT 110 is loaded with software that allows it to establish communication with DSLAM 120, to locate a protocol server, shown as SNMP server 165, and to exchange network management protocol messages. A protocol message is a message that contains protocol information. This information is contained in a MIB. Information contained in a protocol message may include part of, or all of, a MIB. The protocol message can be presented and sent as an object in an object-oriented programming language. For purposes of this invention, a protocol server is software, hardware, or a combination of software and hardware that serves as a host or platform for a protocol. Two examples of protocol servers used in this invention are SNMP server and LDAP server. Also, network management protocol messages are messages for managing and exchanging information with networking equipment, including servers, workstations, routers, switches and hubs etc. on a network.

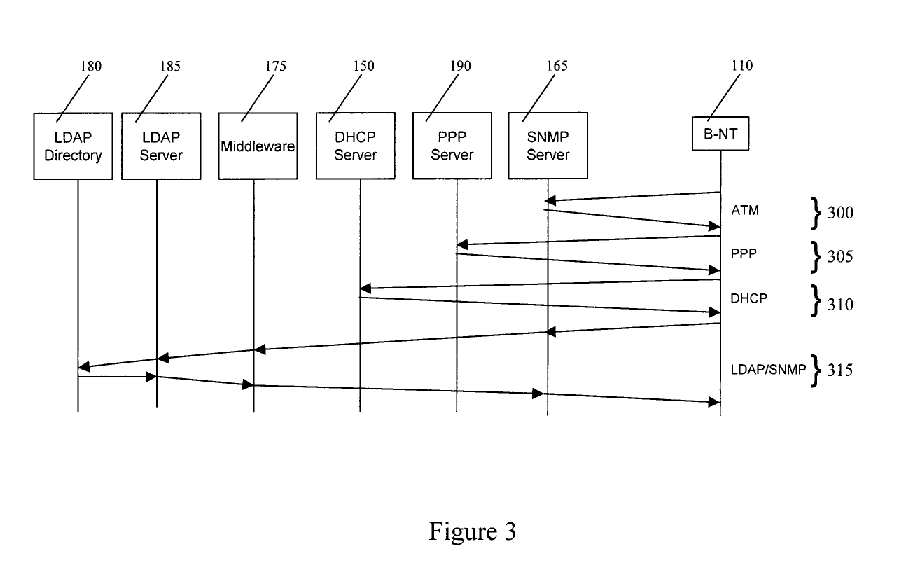

Referring to FIG. 3, there is represented an ATM auto-configuration process 300. In ATM auto-configuration process 300, B-NT 110 is connected to SNMP server 165 and ATM configuration information is downloaded into B-NT 110 using ILMI, usually in the form of MIB elements. Upon completion of the ATM auto-configuration, other protocols, such as PPP and DHCP may be used for additional automatic configuration, using processes such as a PPP process 305, and a DHCP process 310.

In PPP process 305, PPP server 190 residing on gateway/edge router 200 provides IP or ATM configuration information to B-NT 110.

In DHCP process 310, DHCP server 150 provides configuration information using DHCP protocol.

A configuration process 315 facilitates the configuration of B-NT 110 to access a network service. Although configuration process 315 can be used to configure any network service, it is particularly well suited for DSL services and network services such as video on demand, video conferencing, video gaming, broadcast and unicast video, and audio services, such as web radio and CD quality audio. In configuration process 315, network management protocol messages, such as SNMP messages are exchanged between B-NT 110 and SNMP server 165.

The configuration information is provided to B-NT 110 from SNMP server 165. The communication between SNMP server 165 and B-NT 110 can be performed in accordance with either a standard SNMP procedure or a “reverse SNMP” procedure. With a standard SNMP procedure, configuration information is “pushed” to B-NT 110, that is a transfer of the configuration information is initiated by a device in the network. In a “reverse SNMP procedure,” the configuration information is “pulled” by B-NT 110, that is, the transfer is initiated by B-NT 110.

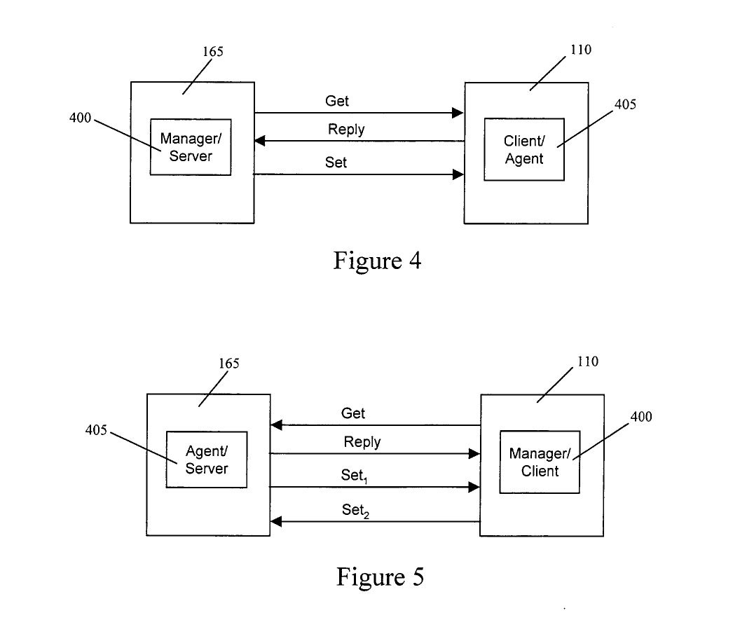

Referring to FIG. 4, there is shown an exchange of information in accordance with the standard SNMP procedure. An SNMP manager 400 initiates SNMP message exchanges with an SNMP agent 405. SNMP manager 400 sends an SNMP Get message such as Get Request, Get Next Request, or Get Bulk, to SNMP agent 405. SNMP agent 405 responds with a Reply message, for example Get Response or Trap, to SNMP manager 400. Subsequently, SNMP manager 400 sends a Set message to SNMP agent 405. The Set message includes the configuration information for configuring B-NT 110.

Referring to FIG. 5, there is shown an exemplary implementation of the “reverse SNMP” procedure. In the “reverse SNMP” procedure, the SNMP manager is the client and the SNMP agent is the server. The SNMP manager initiates SNMP message exchanges, whereby the SNMP manager requests configuration information from the SNMP agent. Thereafter, an SNMP agent sends a reply to the SNMP manager. Subsequently, the SNMP agent sends configuration information to SNMP manager, followed by configuration information sent back to the agent from the manager.

In the preferred embodiment of the present invention, configuration process 315 employs a “reverse SNMP” procedure. Still referring to FIG. 5, in the “reverse SNMP” procedure B-NT 110, through SNMP manager 400, initiates SNMP message exchanges, allowing B-NT 110 to request configuration information for advanced services. As an example, B-NT 110 through SNMP manager 400 sends a Get message to SNMP agent 405 on SNMP server 165. A Get message notifies SNMP agent 405 that B-NT 110 wishes to obtain configuration information. SNMP agent 405 sends a reply to SNMP manager 400. Thereafter, SNMP agent 405 initiates a first Set message, i.e., Set₁, to SNMP manager 400. The first Set message includes the configuration information that is being sought by B-NT 110. In response to the first Set message, and in accordance with the “reverse SNMP” procedure, SNMP manager 400 issues a second Set message, i.e., Set₂, to SNMP agent 405.

SNMP messages from B-NT 110 are transferred from SNMP server 165 to middleware 175. Middleware 175 converts the SNMP messages to LDAP messages, which are then sent to LDAP server 185.

LDAP server 185 initiates an LDAP Search Request message including search parameters, such as a DN and/or other attributes, for identifying entries in LDAP directory 180 to be queried. LDAP directory 180 may send referrals to other LDAP directories or LDAP servers using Search Result Referral messages if a particular DN cannot be found in LDAP directory 180. Information matching the search parameters is returned to LDAP server 185, usually in LDAP Search Result Entry messages. When the search is complete, LDAP directory 180 sends a Search Result Done message to LDAP server 185. The search results are then transferred to middleware 175, converted to SNMP messages, and transferred to SNMP server 165.

SNMP server 165, through SNMP agent 405, sends a Reply message with the requested configuration information to B-NT 110 through SNMP manager 400. The information is presented to the B-NT in the form of MIB elements. Auto-configuration of B-NT 110 is thus accomplished using a protocol and configuration information that is already compatible with B-NT 110.

The present invention enables B-NT 110 to use a succession of protocols in order to automatically gather configuration information from DSL system 100. Although B-NT 110 is not capable of communicating using the LDAP protocol, and consequently it is not capable of directly interfacing with LDAP directory system 170, B-NT 110 may nevertheless be configured for advanced services with little or no intervention by a subscriber or technician, by implementing this invention.

Middleware 175 facilitates the configuration of B-NT 110 to access a network service. Middleware 175, which may be implemented on a server, has a processor (not shown) and an associated memory 177 that contains instructions for controlling the processor to execute configuration process 315. The instructions are preferably organized as program modules. In one embodiment, middleware 175 includes (a) a module for receiving, in SNMP format from SNMP server 165, a request for information for configuring B-NT 110 to access a digital subscriber line (DSL) service, (b) a module for sending a request for the information, in LDAP format, to LDAP directory system 170, (c) a module for receiving the information, in LDAP format, from LDAP directory system 170, (d) a module for converting the information from LDAP format into SNMP format, and (e) a module for transmitting the information to SNMP server 165, for configuring BNT 110. Middleware 175 may also include a module for converting the request from SNMP server 165 from SNMP format to LDAP format.

As mentioned earlier, an NSP 160 may periodically provide updated configuration information to OSS 195. Referencing FIG. 1, NSP 160 conveys the updated configuration information to OSS 195, which populates LDAP directories 180. B-NT 110 may receive the update the next time it sends a Get message to SNMP server 165. In the “reverse SNMP” procedure, B-NT 110 periodically polls the network for updates and changes in configuration information. This periodic update is triggered by an event or an attempt by a subscriber to utilize a service. With a standard SNMP procedure, an SNMP server periodically pushes updates and changes in configuration information to the B-NT 110.

A similar method may be used to provide a subscriber with new services that may be offered by one or more NSPs 160. In this case, an NSP 160 supplies OSS 195 with information identifying the new service, configuration information, and B-NTs to be configured with the new service. OSS 195 populates LDAP directories 180 with the information. LDAP server 185 transmits a message to middleware 175 to notify SNMP server 165 of the new service and the B-NTs to be configured. SNMP server 165 then initiates Set messages through agent 405 to the appropriate B-NTs. In response, the B-NTs send Get messages to agent 405. SNMP agent 405 then sends the configuration information to the B-NTs in Reply messages.

SNMP server 165, middleware 175, LDAP server 185, and LDAP directory 180 are shown and described as separate functions residing on separate independent devices. However, it should be noted that each of these functions may be located together in any combination and may also be located in pre-existing network devices, such as gateways, routers, DSLAMs, etc.

Although DSL system 100 is described herein as having the instructions for configuration process 315 installed into memory 177, the instructions can reside on an external storage media 173 for subsequent loading into memory 177. Storage media 173 can be any conventional storage device, including, but not limited to, a floppy disk, a compact disk, a magnetic tape, a read only memory, or an optical storage media. Storage media 173 could also be a random access memory, or other type of electronic storage, located on a remote storage system and coupled to memory 177.

While the present invention is discussed in the context of automatically configuring a B-NT at a subscriber's location, it should be understood that the present invention may be used to automatically configure any type of networking equipment for receiving a network service, provided the networking equipment is capable of communication and receipt of configuration information using a network management protocol. A network management protocol is a set of rules that manages distributed data communications devices such as modems, routers and bridges.

The present invention enables further flexibility for automatic configuration of advanced services through conversion (LDAP-SNMP) middleware. Once the B-NT acquires the knowledge of the location of the directory using PPP and/or DHCP, the B-NT communicates to the directory via the middleware, allowing MIB elements to be exchanged. The MIB elements communicated between the BNT and the server function represent the encoding of the information stored as an abstraction in a centralized LDAP directory. For the conversion, pre-defined mapping translates SNMP MIB information, originally from the SNMP client software of the B-NT, to LDAP schema at the LDAP directory.

It should also be understood that the present invention is not limited to a specific network management protocol such as SNMP, but may utilize any network management system and manage any nodes (servers, workstations, routers, switches and hubs etc.) on an IP network. A network management system is comprised of one or more of the following management functional areas: configuration, fault, performance, accounting and security.

The present invention having been thus described with particular reference to the preferred forms thereof, it will be obvious that various changes and modifications may be made therein without departing from the spirit of the present invention.

What is claimed is:

1. A method for facilitating a configuration of a device to access a network service, comprising:
receiving, in a first protocol format, a request for information for configuring said device;
retrieving said information, in a second protocol format, from a directory system;
converting said information from said second protocol format to said first protocol format; and
transmitting said information, in said first protocol format, in response to said request.

2. The method of claim 1, wherein said first protocol format conforms to a simple network management protocol (SNMP).

3. The method of claim 1, wherein said second protocol format conforms to a lightweight directory access protocol (LDAP).

4. The method of claim 1,
wherein said first protocol format conforms to a simple network management protocol (SNMP),
wherein said second protocol format conforms to a lightweight directory access protocol (LDAP),
wherein said method further comprises converting said request from an SNMP message to an LDAP directory system message, and
wherein said retrieving comprises sending said LDAP directory system message to said directory system.

5. The method of claim 1, wherein said transmitting comprises transmitting said information to a protocol server.

6. The method of claim 5, wherein said protocol server comprises a simple network management protocol (SNMP) protocol server.

7. The method of claim 1, wherein said directory system comprises a lightweight directory access protocol (LDAP) directory system.

8. The method of claim 1, wherein said network service comprises a digital subscriber line (DSL) service.

9. A method for facilitating a configuration of a device to access a network service, comprising:
receiving a request, in a simple network management protocol (SNMP) format, for information for configuring said device to access a digital subscriber line (DSL) service;
sending a request for said information, in a lightweight directory access protocol (LDAP) format, to an LDAP directory system;
receiving said information, in said LDAP format, from said LDAP directory system;
converting said information from said LDAP format into said SNMP format; and
transmitting said information to an SNMP protocol server, for configuring said device.

10. An apparatus for facilitating a configuration of a device to access a network service, comprising:
a module for receiving, in a first protocol format, a request for information for configuring said device;
a module for retrieving said information, in a second protocol format, from a directory system;
a module for converting said information from said second protocol format to said first protocol format; and
a module for transmitting said information, in said first protocol format, in response to said request.

11. The apparatus of claim 10, wherein said first protocol format conforms to a simple network management protocol (SNMP).

12. The apparatus of claim 10, wherein said second protocol format conforms to a lightweight directory access protocol (LDAP).

13. The apparatus of claim 10,
wherein said first protocol format conforms to a simple network management protocol (SNMP),
wherein said second protocol format conforms to a lightweight directory access protocol (LDAP),
wherein said apparatus further comprises a module for converting said request from an SNMP message to an LDAP directory system message, and
wherein said module for retrieving sends said LDAP directory system message to said directory system.

14. The apparatus of claim 10, wherein said module for transmitting transmits said information to a protocol server.

15. The apparatus of claim 14, wherein said protocol server comprises a simple network management protocol (SNMP) protocol server.

16. The apparatus of claim 10, wherein said directory system comprises a lightweight directory access protocol (LDAP) directory system.

17. The apparatus of claim 10, wherein said network service comprises a digital subscriber line (DSL) service.

18. An apparatus for facilitating a configuration of a device to access a network service, comprising:
a module for receiving, in a simple network management protocol (SNMP) format, a request for information for configuring said device to access a digital subscriber line (DSL) service;
a module for sending a request for said information, in a lightweight directory access protocol (LDAP) format, to an LDAP directory system;
a module for receiving said information, in said LDAP format, from said LDAP directory system;
a module for converting said information from said LDAP format into said SNMP format; and
a module for transmitting said information to an SNMP protocol server, for configuring said device.

19. A system for facilitating a configuration of a device for accessing a network service, comprising:
a protocol server being connected to said device through a network, wherein said device requests, from said protocol server, information to configure said device to access said network service;
a directory system being connected to said network and having said information; and
a converter for interfacing with said protocol server using a first protocol format, and for interfacing with said directory system using a second protocol format,
wherein said protocol server retrieves said information from said directory system via said converter.

20. The system of claim 19, wherein said protocol server transmits said information to said device.

21. The system of claim 19, wherein said protocol server comprises a simple network management protocol (SNMP) server.

22. The system of claim 21, wherein said device requests said information using a reverse SNMP procedure.

23. The system of claim 19, wherein said directory system is a lightweight directory access protocol (LDAP) system.

24. The system of claim 19,
wherein said interfacing with said protocol server using a first protocol format comprises communicating a network protocol message from said protocol server, and
wherein said interfacing with said directory system comprises using said second protocol format comprises communicating a directory system message.

25. A storage media containing instructions for controlling a processor to facilitate a configuration of a device to access a network service, said storage media comprising:
a module for controlling said processor to receive, in a first protocol format, a request for information for configuring said device;
a module for controlling said processor to retrieve said information, in a second protocol format, from a directory system;
a module for controlling said processor to convert said information from said second protocol format to said first protocol format; and
a module for controlling said processor to transmit said information, in said first protocol format, in response to said request.

26. A storage media containing instructions for controlling a processor to facilitate a configuration of a device to access a network service, said storage media comprising:
a module for controlling said processor to receive, in a simple network management protocol (SNMP) format, a request for information for configuring said device to access a digital subscriber line (DSL) service;
a module for controlling said processor to send a request for said information, in a lightweight directory access protocol (LDAP) format, to an LDAP directory system;
a module for controlling said processor to receive said information, in said LDAP format, from said LDAP directory system;
a module for controlling said processor to convert said information from said LDAP format into said SNMP format; and
a module for controlling said processor to transmit said information to an SNMP protocol server, for configuring said device.

27. A method for facilitating a configuration of a device to access a network service, comprising:
receiving a request, in a first protocol format, for information for configuring said device;
converting said request from said first protocol format to a second protocol format;
sending said request, in said second protocol format, to a directory system;
receiving said information, in said second protocol format, from said directory system;
converting said information from said second protocol format to said first protocol format; and
transmitting said information, in said first protocol format, in response to said received request.

28. A method for facilitating a configuration of a device to access a network service, comprising:
receiving a request, in a simple network management protocol (SNMP) format, for information for configuring said device to access a digital subscriber line (DSL) service;
converting said request from said SNMP format to a lightweight directory access protocol (LDAP) format;
sending said request in said LDAP format, to an LDAP directory system;
receiving said information, in said LDAP format, from said LDAP directory system;
converting said information from said LDAP format into said SNMP format; and
transmitting said information to an SNMP protocol server, for configuring said device.

29. An apparatus for facilitating a configuration of a device to access a network service, comprising:
a module for receiving, in a first protocol format, a request for information for configuring said device;
a module for converting said request from said first protocol format to a second protocol format;
a module for sending said request in said second protocol format to a directory system;
a module for receiving said information, in said second protocol format, from said directory system;
a module for converting said information from said second protocol format to said first protocol format; and
a module for transmitting said information, in said first protocol format, in response to said received request.

30. An apparatus for facilitating a configuration of a device to access a network service, comprising:
a module for receiving, in a simple network management protocol (SNMP) format, a request for information for configuring said device to access a digital subscriber line (DSL) service;
a module for converting said request from said SNMP format to a lightweight directory access protocol (LDAP) format;
a module for sending said request in said LDAP format, to an LDAP directory system;
a module for receiving said information, in said LDAP format, from said LDAP directory system;
a module for converting said information from said LDAP format into said SNMP format; and
a module for transmitting said information to an SNMP protocol server, for configuring said device.

31. A storage media containing instructions for controlling a processor to facilitate a configuration of a device to access a network service, said storage media comprising:
a module for controlling said processor to receive, in a first protocol format, a request for information for configuring said device;
a module for controlling said processor to convert said request from said first protocol format to a second protocol format;
a module for controlling said processor to send said request in said second protocol format, to a directory system;
a module for controlling said processor to receive said information, in said second protocol format, from said directory system;
a module for controlling said processor to convert said information from said second protocol format to said first protocol format; and
a module for controlling said processor to transmit said information, in said first protocol format, in response to said received request.

32. A storage media containing instructions for controlling a processor to facilitate a configuration of a device to access a network service, said storage media comprising:
a module for controlling said processor to receive, in a simple network management protocol (SNMP) format, a request for information for configuring said device to access a digital subscriber line (DSL) service;
a module for controlling said processor to convert said request from said SNMP format to a lightweight directory access protocol (LDAP) format;
a module for controlling said processor to send a request for said information, in said LDAP format, to an LDAP directory system;
a module for controlling said processor to receive said information, in said LDAP format, from said LDAP directory system;
a module for controlling said processor to convert said information from said LDAP format into said SNMP format; and
a module for controlling said processor to transmit said information to an SNMP protocol server, for configuring said device.
